(19) United States
(12) Patent Application Publication
(10) Pub. No.: US 2004/0142806 A1
(43) Pub. Date: Jul. 22, 2004

(54) Dunnage converter system, components and method

(76) Inventors: Dan Coppus, Amstenrade (NL); Ralmond P.M. Demers, Landgraaf (NL); Edward W. Lintala, Concord, OH (US); Thomas E. Manley, Mentor, OH (US); James A. Simmons, Painesville Twp., OH (US); Joseph J. Harding, Mentor, OH (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/696,746

(22) Filed: Oct. 29, 2003

Related U.S. Application Data
(60) Provisional application No. 60/421,996, filed on Oct. 29, 2002.

(51) Int. Cl. B31F 7/00

(52) U.S. Cl. 493/350

(57) ABSTRACT

A dunnage converter system (10), components and method are disclosed. A support device (14) supporting one or more stacks (61-65) of fan-folded sheet stock material is provided. Stock material is supplied from the support device (14) to a dunnage converter (12) when the support device (14) is positioned in proximity thereto. A supply of sheet stock material (18) for use with a dunnage converter includes at least one continuous ply of sheet stock material that is fan-folded, and includes a series of folds that together form a sequence of rectangular pages, the pages being piled accordion style one on top of the other to form the stack(s) (61-65) of sheet stock material.

The applicants hereby claim the benefit of U.S. Provisional Patent Application No. 60/421,996 filed on Oct. 29, 2002, which is hereby incorporated herein by reference.

### FIELD OF THE INVENTION

The present invention relates to a dunnage converter system, method and supply of fan-folded sheet stock material for a dunnage converter system.

### BACKGROUND OF THE INVENTION

Dunnage converters convert sheet stock material into a relatively low density dunnage product that is useful in providing cushioning in packages. The dunnage converter draws sheet stock material from a supply, such as a roll of sheet stock material or a stack of fan-folded sheet stock material. Fan-folded sheet stock material is particularly desirable when the dunnage converter operates at relatively higher speeds to produce a void fill dunnage product. The advantage of fan-folded sheet stock material, in contrast to a stock roll of sheet material, is that there is minimal or no inertia to overcome. Consequently, fan-folded sheet stock material exhibits less drag on the converting components of the dunnage converter. Also, increased operating speeds are possible, and edge-tension problems are minimized, when the fan-folded stock material is used instead of rolled stock material.

With the increased operating speeds, product output efficiency is improved. Increased production, however, also results in faster usage of the sheet stock material. To meet this increased usage of sheet stock material, more effective and more efficient means of delivering and supplying sheet stock material to the dunnage converter are desired.

### SUMMARY OF THE INVENTION

The present invention provides a dunnage converter system which affords one or more advantages and improvements over known dunnage conversion systems.

The present invention provides a method of supplying fan-folded sheet stock material to a dunnage converter. The method includes the steps of positioning two or more stacks of fan-folded sheet stock material proximate a dunnage converter, and feeding the sheet material from the stacks of fan-folded sheet stock material to the converter, either sequentially or simultaneously, for conversion into a dunnage product.

The present invention also provides a dunnage conversion system. The system includes a dunnage converter for converting sheet stock material into a dunnage product, and a supply of sheet stock material proximate the dunnage converter for conversion into a dunnage product. The supply includes two or more stacks of fan-folded sheet stock material that are horizontally or vertically disposed relative to each other.

Also provided by the present invention is a supply of sheet stock material for use with a dunnage converter. The supply includes a continuous ply of sheet stock material that is fan-folded, with a series of folds that together form a sequence of rectangular pages. The pages are piled accordion style one on top of the other to form multiple stacks of sheet stock material.

The present invention also contemplates the combination of a dunnage converter and a portable support device for supporting at least one stack of fan-folded sheet stock material and from which stock material is supplied to the dunnage converter when the support device is positioned in proximity thereto.

The present invention also contemplates a cart for supporting at least one stack of fan-folded sheet stock material. The cart has a pair of spaced upright members adapted to receive therebetween at least one stack of fan-folded sheet stock material. The upright members have an inward-facing channel for supporting the sides of the stock material to maintain the stack upright.

### BRIEF DESCRIPTION OF THE DRAWINGS

FIG. 1 is a front perspective view of a dunnage conversion system including a dunnage converter and a dunnage converter stand, a supply of fan-folded sheet stock material, and a pallet for supporting the supply of fan-folded sheet stock material in accordance with an embodiment of the present invention, the pallet being shown displaced from the dunnage converter stand.

FIG. 2 is a front perspective view similar to FIG. 1, with the pallet straddled by the stand.

FIG. 3 is a side elevation view of an exemplary dunnage converter for converting sheet stock material, with an exemplary arrangement of the internal components being shown within the housing of the dunnage converter.

FIG. 4 is a schematic side elevational view of the pallet and supply of fan-folded sheet stock material shown in FIGS. 1 and 2.

FIG. 5 is an exploded schematic side elevational view of the supply of fan-folded sheet stock material shown in FIGS. 1 and 2.

FIG. 6 is a schematic side elevational view of a stack of fan-folded sheet stock material, the trailing ply thereof having an adhesive layer and release liner.

FIG. 7 is a side elevational view a dunnage-converter, a dunnage converter stand, a supply of fan-folded sheet stock material, and a pallet for supporting the supply of fan-folded sheet stock material in accordance with an embodiment of the present invention, the pallet being straddled by the stand.

FIG. 8 is a side elevational view a dunnage converter, a dunnage converter stand, a supply of fan-folded sheet stock material, and a pallet for supporting the supply of fan-folded sheet stock material in accordance with an embodiment of the present invention, the pallet being straddled by the stand.

FIG. 9 is a perspective view of a supply of multi-ply sheet stock material in fan-folded form.

FIG. 10 is a side elevational view of a dunnage converter, a dunnage converter stand, a supply of fan-folded sheet stock material, and a supply stand for supporting the supply of fan-folded sheet stock material in accordance with an embodiment of the present invention.

FIG. 11 is a cross-sectional view of the supply stand as seen along the line 11-11 of FIG. 1 0.

FIG. 11A is a cross-sectional view, similar to FIG. 11, of an alternative supply stand provided by the present invention.

FIGS. 12-16 illustrate sequentially several views of an exemplary technique for inserting a stack of fan-folded sheet stock material into the supply stand of FIG. 10.

FIG. 17 is a side elevational view of a dunnage converter, a partial view of a dunnage converter stand, a schematic illustration of a supply of fan-folded sheet stock material, and a supply tray for supporting the fan-folded sheet stock material in accordance with an embodiment of the present invention.

FIG. 18 is a side elevational view of a dunnage converter, a partial view of a dunnage converter stand, a supply of fan-folded sheet stock material, and a supply tray for supporting the supply of fan-folded sheet stock material in accordance with an embodiment of the present invention.

FIG. 19 is a side elevational view of a dunnage converter, a dunnage converter stand, a schematic illustration of a supply of fan-folded sheet stock material, and a paddle type elevator for supporting the supply of fan-folded sheet stock material in accordance with an embodiment of the present invention.

### DETAILED DESCRIPTION

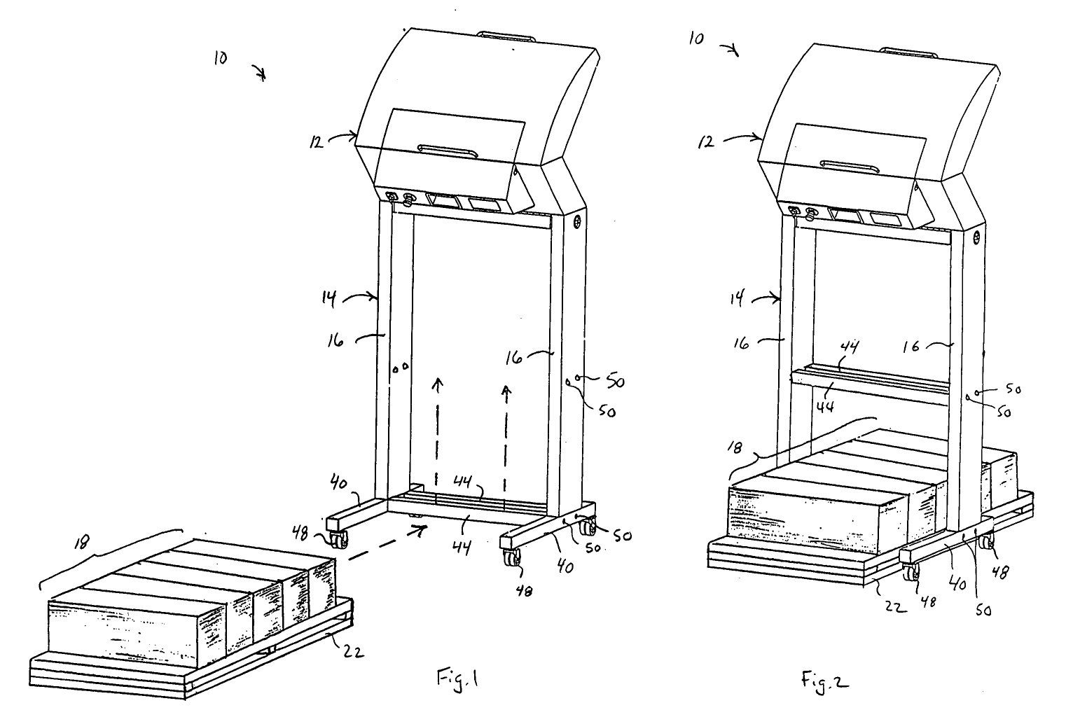

Referring now to the drawings in detail, and initially to FIGS. 1 and 2, a dunnage conversion system in accordance with an embodiment of the present invention is designated generally by reference number 10. The dunnage conversion system 10 includes a dunnage converter 12 (also referred to as a dunnage converter head) and a dunnage converter stand 14 including a pair of transversely spaced upright members 16. Also shown is a supply of fan-folded sheet stock material 18 and a support device, such as a pallet 22, for supporting the supply of fan-folded sheet stock material 18. The sheet stock material 18 and the pallet 22 may be easily inserted between the upright members 16 (or legs) of the dunnage converter stand 14 and below the dunnage converter 12, where the pallet 22 is substantially out of the way from a packaging area being serviced by the dunnage converter 12, and from where sheet stock material 18 may be drawn from the supply and converted into a strip of dunnage by the dunnage converter 12. Also in accordance with a preferred embodiment of the present invention, once a supply of sheet stock material 18 has been almost spent, a succeeding supply of sheet stock material may be spliced to the almost spent supply of sheet stock material, even while the dunnage converter 12 draws and converts sheet stock material from the almost spent supply of sheet stock material, such that a converting process need not be interrupted.

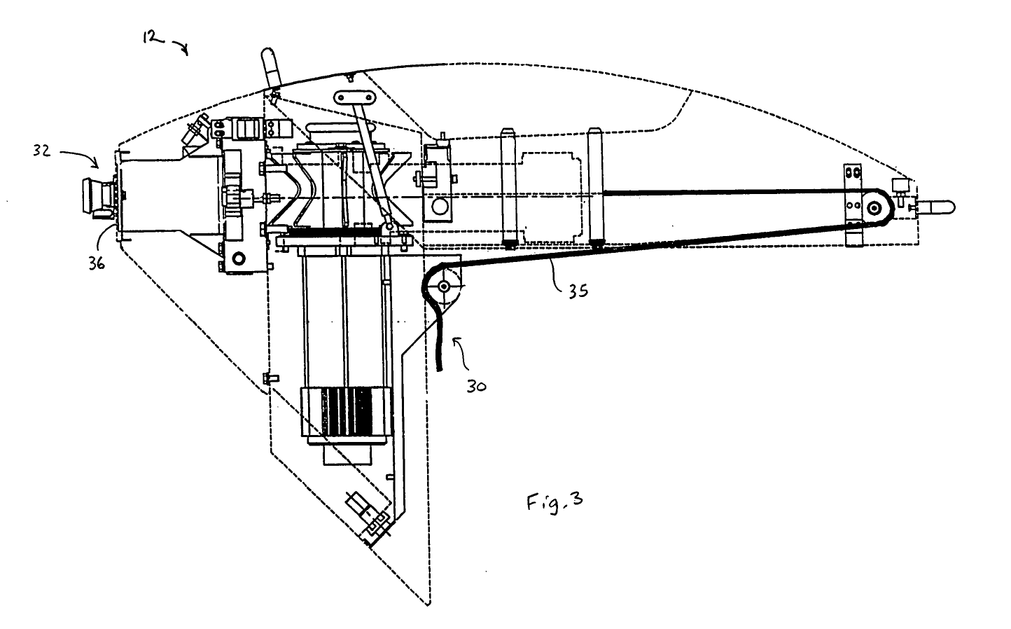

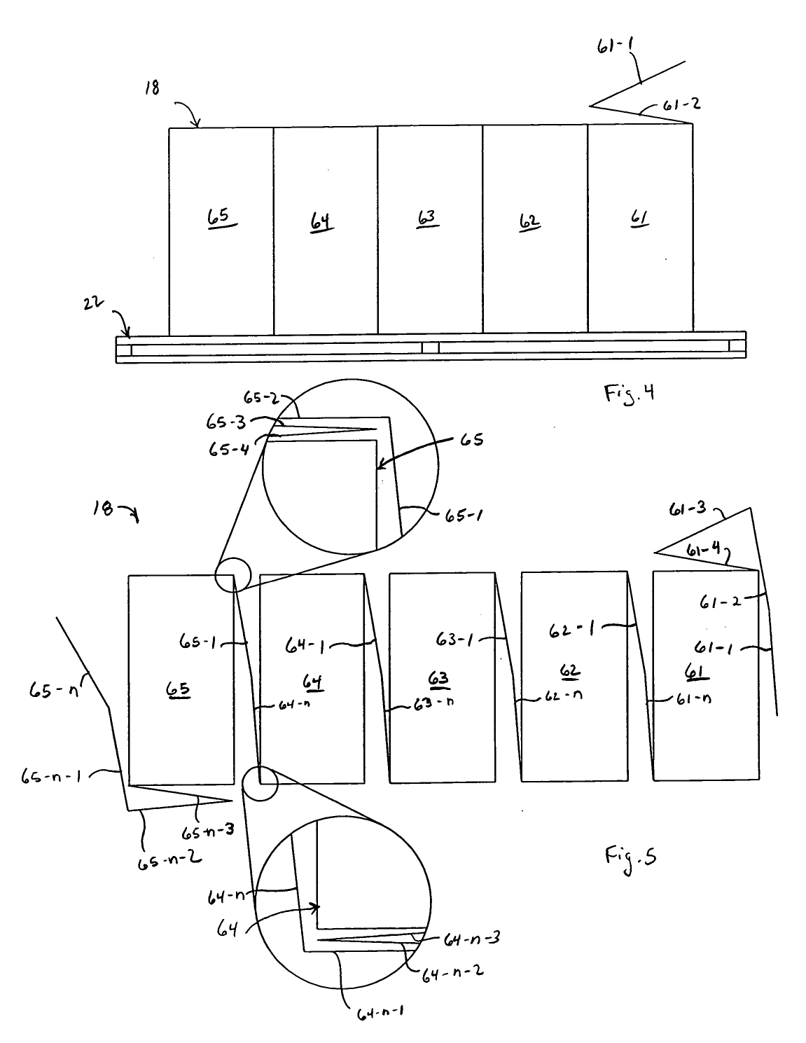

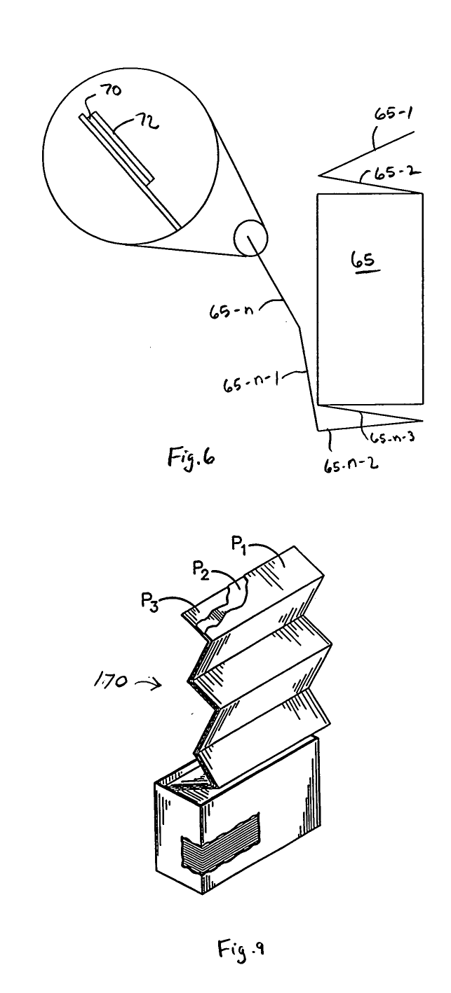

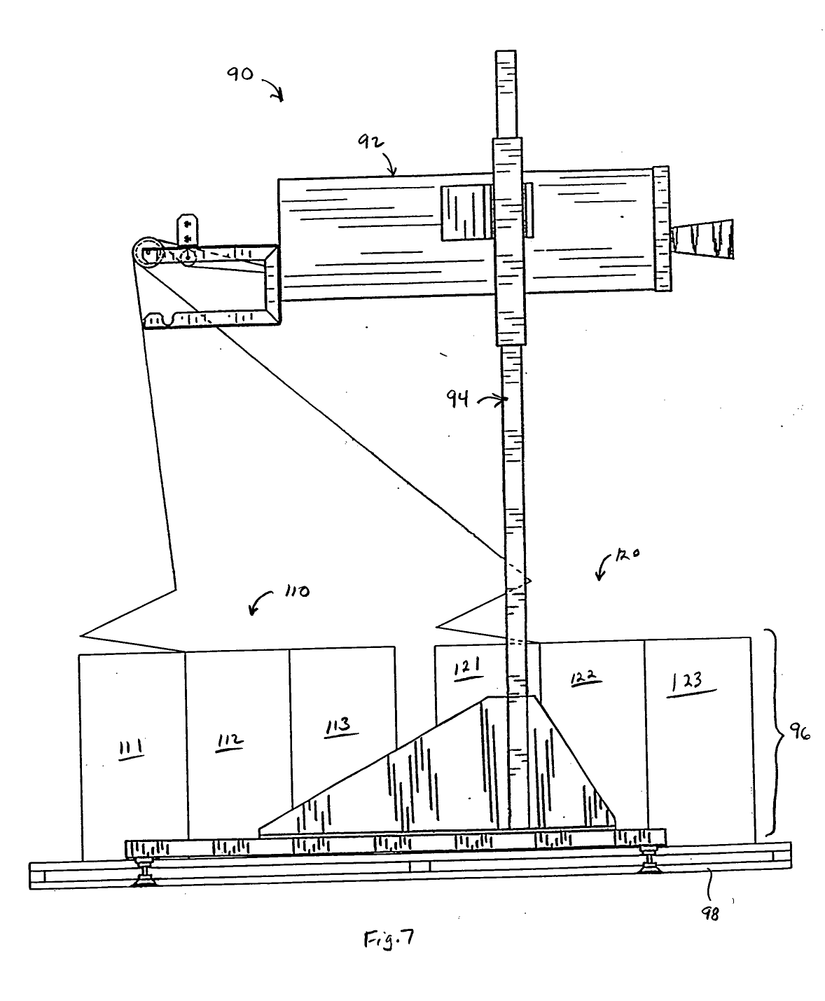

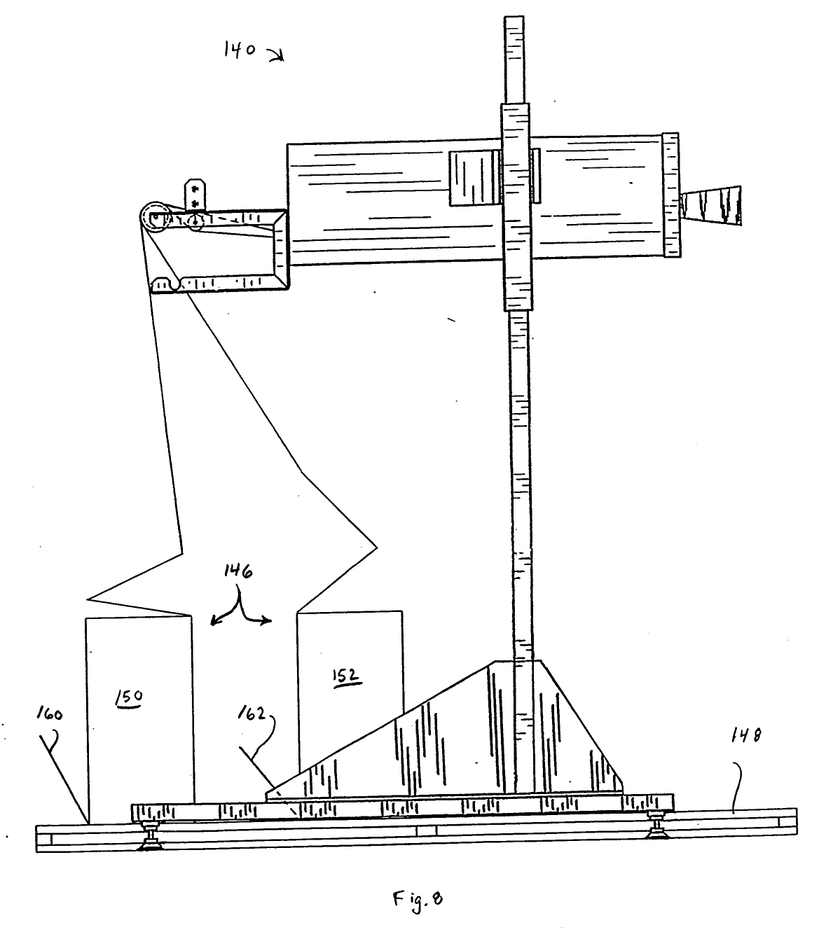

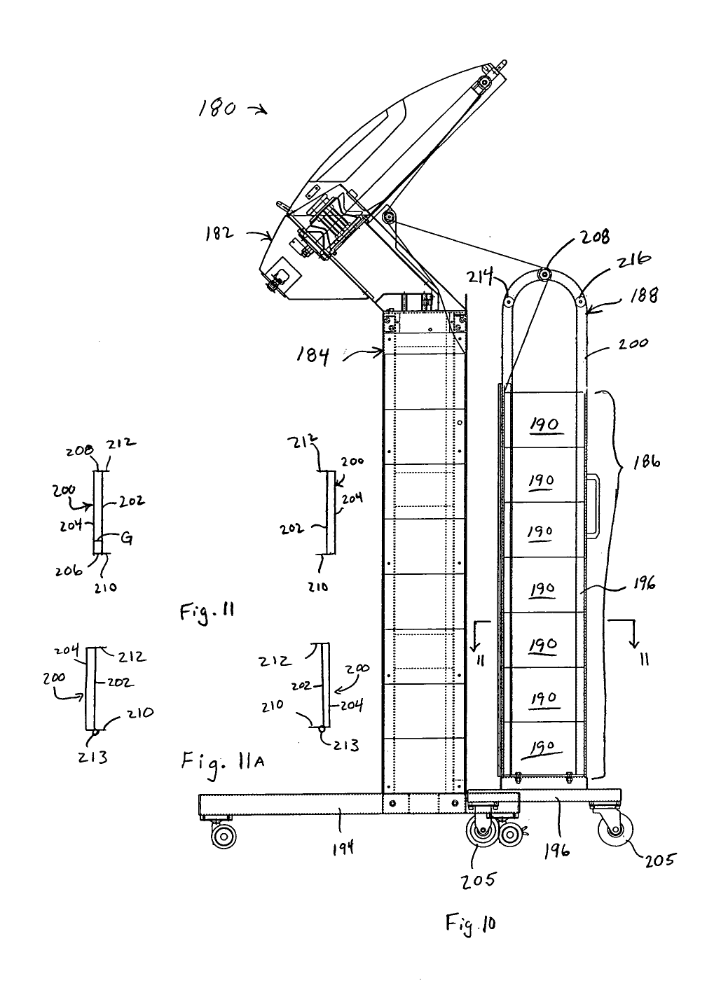

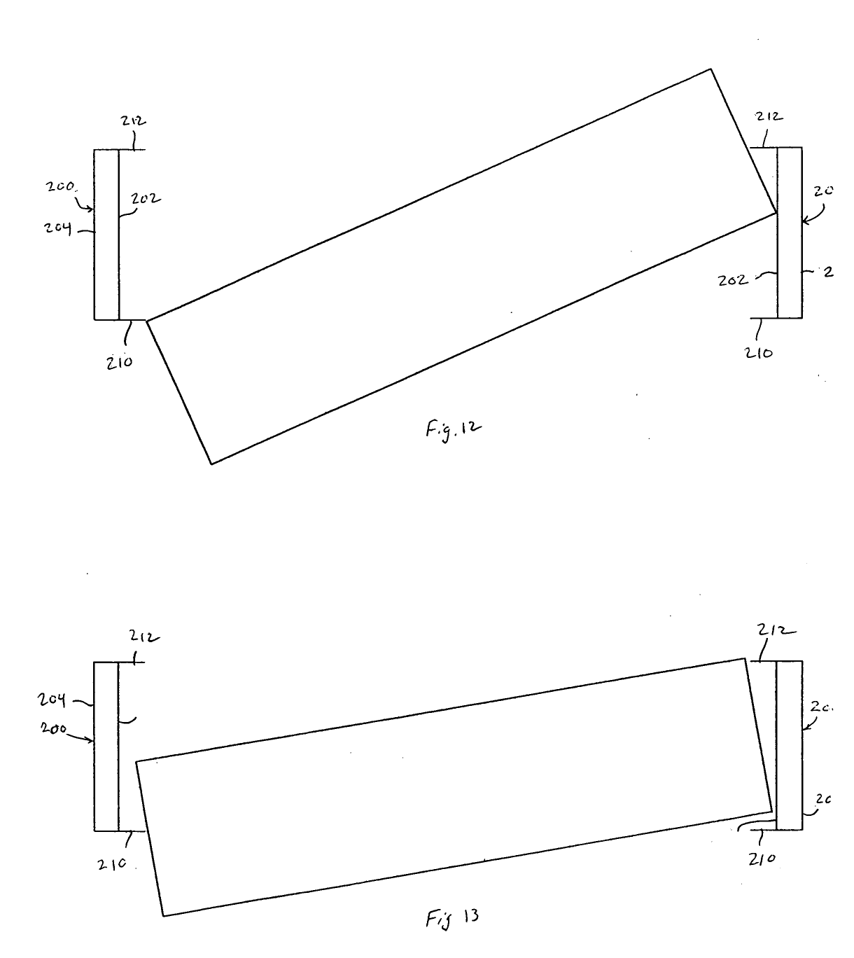

Turning to details of the system components, FIG. 3 illustrates an exemplary dunnage converter 12 for use in the dunnage conversion system 10. The illustrated dunnage converter 12 has an upstream end 30 at which sheet stock material is supplied to the dunnage converter 12, and a downstream end 32 from which the dunnage converter 12 discharges a strip of dunnage product. As used herein, the terms upstream and downstream refer to a travel path of sheet stock material, illustrated at 35 (FIG. 3), as it passes from the dunnage converter stand 14 to an outlet 36 of the dunnage converter 12 as a strip of dunnage product. The dunnage product produced by the illustrated converter may be severed to discrete lengths if desired, and is particularly suited for use as void fill during shipping. Preferred dunnage converters are shown and described in U.S. patent application Ser. Nos. 09/878,130, 60/375,149 and 60/412,127, which are hereby incorporated herein by reference in their entireties.

The converter 12 is supported by the stand 14. In addition to the aforementioned upright members 16, the stand 14 further includes a pair of base members 40 and a pair of transverse support members 44. The dunnage converter 12 is mounted to the upper ends of the upright members 16. Wheels 48 are provided at longitudinally opposite ends of the base members 40 so that the stand 14 and dunnage converter 12 may be moved easily. In the illustrated embodiment, the transverse support members 44 are selectively connectable between the respective upright members 16 at either a lower position proximate the base members 40 as shown in FIG. 1 or an elevated pallet receiving position shown in FIG. 2. In the pallet receiving position of FIG. 2, the transverse support members 44 are elevated sufficiently to enable a pallet 22 of sheet stock material to be inserted between the upright members 16 and under the transverse support members 44. The sheet stock material from the supply 18 thereof may be routed through the gap between the transverse support members 44 at their upper position for guiding movement of same during, for example, a dunnage converting process. In the illustrated embodiment, the transverse support members 44 are disposed vertically about halfway between the base members 40 of the stand 14 and the tops of the upright members 16. It will be appreciated that other or additional positions may be provided to which the transverse support members 44 may be selectively positioned, for example, to accommodate a wider range in heights of the stacks of sheet stock material. Also, it will be appreciated that any number of transverse support members 44 may be provided, even one for example.

While a floor-supported pallet 22 is shown between the upright members 16 in FIGS. 1 and 2, other support devices for supplying sheet stock material 18 can be used. For example, the pallet 22 may be supported by a cart, or a cart may be used in place of the pallet 22.

The pallet 22 and the stacks of sheet stock material 18 supported by the pallet 22, have a width sufficiently narrow to enable the pallet 22 and supply of sheet stock material 18 to be slid between the upright members 16 of the stand 14. Thus, the width of the pallet 22 and fan-folded sheet stock material 18 is slightly less than the width between the upright members 16 of the stand 14. In the illustrated exemplary embodiment the pallet 22 supports five stacks of fan-folded sheet stock material side-by-side.

In FIG. 1, the pallet 22 of sheet stock material is shown positioned in front of the dunnage converter stand 14 and aligned longitudinally with respect to the base members 40 of the stand 14 for inserting the pallet 22 of sheet stock material therebetween and below the dunnage converter 12. In the illustrated embodiment, the pallet 22 of sheet stock material is inserted between the base members 40 and the upright members 16 of the stand 14 in a direction from the front of the stand 14 to the rear of the stand 14, as is indicated by the arrow at reference number 50. It will be appreciated that the pallet 22 may alternatively be inserted from the rear of the stand 14. Alternatively, the dunnage converter 12 and stand 14 may be moved via the wheels 48 in a forward or rearward manner such that the base members 40 and upright members 16 straddle the pallet 22 of sheet stock material therebelow. FIG. 2 shows the pallet 22 positioned between the upright members 16 of the stand 14 and below the dunnage converter 12.

FIGS. 4 and 5 show the pallet 22 and supply 18 of sheet stock material in greater detail. As is illustrated in FIGS. 4 and 5, the supply of sheet stock material 18 preferably includes a continuous strip or ply of sheet stock material that includes a series of folds which together form a sequence of rectangular pages 61-1,61-2, . . . , 62-1, . . . , 63-1, . . . , 64-1, . . . , 65-1, . . . , 65-n, that are fan-folded into five rectangular stacks 61-65. Each stack 61-65 includes a plurality of rectangular pages that are piled accordion style one on top of the other to form the stack of sheet stock material. For example, pages 61-1, 61-2, . . . , and 61-n, form the stack 61 of sheet stock material. Adjacent stacks 61-65 are connected together as illustrated in FIG. 5, for example. Thus, for example, the trailing page (for example 61-n) of a stack of sheet stock material is separated by a fold from the leading page (for example 62-1) of an adjacent stack of sheet stock material. In the illustrated exemplary embodiment, each stack 61-65 of sheet stock material has a height that is about the same as the length of two consecutive pages of sheet stock material. Of course, the stacks 61-65 may be higher or lower in height as may be suitable for a particular packaging application.

In the illustrated preferred embodiment of the invention, the pallet 22 (or other support device) and supply of sheet stock material 18 are packaged together to form a single easily transportable and storable package of sheet stock material. For example, the pallet 22 and multiple stacks 61-65 of sheet stock material may be enclosed by a plastic wrap or cardboard jacket. Alternatively, the multiple stacks 61-65 of sheet stock material may be otherwise contained for shipment. In any event, an end user need merely unpackage the packaged pallet 22 or supply of sheet stock material 18, and feed the leading end of the continuous ply of sheet stock material (for example, the rectangular page 61-1) into the dunnage converter 12 to initiate a dunnage conversion process. Replacement of the supply of sheet stock material 18 need not occur until all five stacks 61-65 forming the supply of sheet stock material 18 are nearly or completely spent.

When the supply of sheet stock material 18 is nearly spent, a succeeding supply of sheet stock material may be spliced to the nearly spent supply of sheet stock material. To this end, the leading page of a succeeding supply of sheet stock material, for example 61-1 of the supply of sheet stock material 18, may be spliced to the trailing page of a nearly spent supply of sheet stock material, for example 65-n of the supply of sheet stock material 18.

The succeeding and almost spent supplies of sheet stock material may be spliced together by any suitable means, for example, by taping, gluing, or other attaching means. In an embodiment of the invention, as is shown in FIG. 6, the leading end of the trailing page of the almost spent supply of sheet stock material 18 is provided with a pressure sensitive adhesive layer 70 and a release liner 72, with the release liner 72 covering the pressure sensitive adhesive layer 70. An exemplary adhesive layer and release liner can take the form of an adhesive transfer tape having an acrylic adhesive and a paper strip release liner. By releasing the liner 72, such as by manually peeling same from the pressure sensitive adhesive layer 70, the trailing end of the trailing page of the almost spent supply of sheet stock material may be spliced to, or more particularly adhered to, the leading end of a leading page of a succeeding supply of sheet stock material. It will be appreciated that the adhesive layer and release liner may alternatively be provided on the leading end of the succeeding supply of sheet stock material rather than on the trailing end of the almost spent supply of sheet stock material. Also, although in the illustrated embodiment the adhesive layer and release liner are disposed on the top surface of the trailing end of sheet stock material, the adhesive layer and release liner may alternatively be disposed on the bottom surface of the trailing end.

As will be appreciated, a converting process need not be interrupted in order to splice together a succeeding supply of sheet stock material and an almost spent supply of sheet stock material. For example, as a converting process is taking place, the leading edge of a succeeding pallet of sheet stock material may be abutted against the trailing edge of the almost spent pallet of sheet stock material from which the dunnage converter 12 draws and converts sheet stock material. The succeeding pallet of sheet stock material may then be urged forward between the base members 40 and the upright members 16 of the stand 14, thereby urging from underneath the dunnage converter 12 the almost spent supply of sheet stock material and replacing same with the succeeding pallet of sheet stock material. The succeeding supply of sheet stock material may be spliced to the almost spent supply of sheet stock material before or after the succeeding supply of sheet stock material is inserted below the dunnage converter 12.

FIG. 7 shows a dunnage conversion system 90 in accordance with another embodiment of the present invention. The conversion system 90 includes a dunnage converter 92 and a dunnage converter stand 94. A supply of fan-folded sheet stock material 96 is provided along with a pallet 98 (or other suitable support device) for supporting the supply of fan-folded sheet stock material 96. The pallet 98 and supply of sheet stock material 96 are shown between the stand uprights 102 and below the dunnage converter 92. The converter, for example, may be a converter like that shown and described in U.S. Pat. Nos. 5,123,889 and 5,836,538, which are hereby incorporated herein by reference in their entireties, such converters typically convert multi-ply sheet stock material into a dunnage product.

The supply 96 of sheet stock material is in the form of multiple sets 110 and 120 of one or more stacks 111-113 and 121-123 of continuous sheet stock material. In the illustrated embodiment, the supply 96 include two sets 110 and 120 of three stacks 111-113 and 121-123 of sheet stock material. Each set 110 and 120 is made up of a continuous strip or ply of sheet stock material that is fan-folded, and includes a series of folds that together form a sequence of rectangular pages. The pages are piled accordion style one on top of the other to form the respective stacks 111-113 and 121-123 of sheet stock material. In the FIG. 7 embodiment, the trailing page of a stack of sheet stock material is separated by a fold from the leading page of an adjacent stack of sheet stock material. Also, in the illustrated embodiment each stack 111-113 and 121-123 of sheet stock material has a height that is substantially the same as the length of two consecutive pages of sheet stock material.

During a dunnage conversion process, the dunnage converter 92 draws and converts sheet stock material from both sets of 110 and 120 of the three stacks 111-113 and 121-123 of continuous sheet stock material. More particularly, the dunnage converter 92 has an upstream end 130 at which sheet stock material from the two sets of 110 and 120 of the three stacks 111-113 and 121-123 is supplied to the dunnage converter 92, and a downstream end 132 from which the dunnage converter 92 discharges a strip of dunnage product. The strip of dunnage product produced by the dunnage converter 92 includes two plies of sheet stock material.

Like the aforedescribed pallet 22 and supply of sheet stock material 18, the pallet 98 and supply of sheet stock material 96 in this embodiment may be packaged together to form a single easily transportable or storable package of sheet stock material. Thus, the pallet 98 and two sets 110 and 120 of multiple stacks 111-113 and 121-123 of sheet stock material may be wrapped together as a single unit, or the individual set 110 of three stacks 111-113 of sheet stock material (or the individual set 120 of three stacks 121-123 of sheet stock material) may be maintained in their stacked and side-by-side configuration by means of a plastic or cardboard jacket or one or more bale ties, and then deposited onto the pallet 98 at the end users' site.

When the supply of sheet stock material 96 is almost spent or spent, a succeeding pallet 98 and a succeeding supply of sheet stock material 96 may be inserted between the upright members of the stand 94 and below the dunnage converter 92, thereby displacing the presently-existing pallet. The sheet stock material from the succeeding supply of sheet stock material 96 may then be fed into the dunnage converter 92 thereabove, or spliced to the trailing ends of the plies of the almost spent supply of sheet stock material. The dunnage conversion process can then resume.

Alternatively, when a set of three stacks of sheet stock material (for example, the set 110 of the three stacks 111-113) is almost spent, a succeeding set of three stacks of sheet stock material may be deposited onto the pallet 98 adjacent the almost spent set, and the leading end of the succeeding set spliced to the trailing end of the almost spent set. The almost spent set and the succeeding set may be moved about on the pallet as desired to facilitate the splicing of same and the aligning of the sheet stock material with respect to the dunnage converter 92 disposed thereabove. As a result, a converting process need not be interrupted in order to splice together a succeeding set and an almost spent set, as such splicing may occur while the dunnage converter 92 draws and converts sheet stock material into a strip of dunnage. Also, each set 110 and 120 of three stacks 111-113 and 121-123 of sheet stock material may be replenished independent of the other set 110 and 120.

In another embodiment (not shown), a dunnage conversion system includes two supplies of sheet stock material that are respectively supported by two pallets. In such an embodiment, the pallets of sheet stock material are replenished independent of one another. For example, one pallet and supply of sheet stock material may be replaced from the front of the stand, and the other pallet and supply of sheet stock material may be replaced from the rear of the stand.

FIG. 8 shows a dunnage conversion system 140 in accordance with another embodiment of the present invention. The conversion system 140 is similar to the dunnage conversion system 90 except as described below. In the Figures, like reference numerals correspond to like components.

The dunnage conversion system 140 includes a supply of fan-folded sheet stock material 146, and a pallet 148 for supporting the supply of fan-folded sheet stock material 146. Here, the supply of sheet stock material 146 is in the form of two separate stacks 150 and 152 of fan-folded sheet stock material. Each stack 150 and 152 is made up of a continuous strip or ply of sheet stock material that is fan-folded, and includes a series of folds that together form a sequence of rectangular pages. The pages are piled accordion style one on top of the other to form the respective stacks 150 and 152 of sheet stock material. In the illustrated embodiment, each stack 150 and 152 of sheet stock material has a height that is substantially the same as the length of two consecutive pages of sheet stock material.

Each stack 150 and 152 of sheet stock material includes a trailing end 160 and 162 that is provided with a pressure sensitive adhesive layer and a release liner in a manner similar to that set forth above with respect to FIG. 6, to facilitate splicing of same to a leading end of a succeeding stack of sheet stock material. With such an embodiment, the almost spent stack of sheet stock material may be easily replenished, for example manually, with a succeeding stack of sheet stock material, as such stack is relatively light as compared to multiple stacks, for example. It will be appreciated that the adhesive layer and release liner may alternatively be provided on the leading end of the succeeding supply of sheet stock material rather than on the trailing end of the almost spent supply of sheet stock material. Also, although in the illustrated embodiment the adhesive layer and release liner are disposed on the top surface of the trailing end of sheet stock material, the adhesive layer and release liner may alternatively be disposed on the bottom surface of the trailing end.

In each of the above described embodiments, although the fan-folded stock material comprises a single ply of the sheet material, multi-ply arrangements, such as two-ply or three-ply arrangements, may alternatively be used in the present invention. The number of plies of the sheet material may vary depending upon the characteristics of the dunnage converter being used and/or the desired qualities of the dunnage product being created. FIG. 9 shows an exemplary stack 170 of multi-ply fan-folded sheet stock material including three plies P1, P2 and P3, for example.

FIG. 10 illustrates a dunnage conversion system 180 in accordance with another embodiment of the present invention. The dunnage converter system 180 includes a dunnage converter 182 and a dunnage converter stand 184. Also shown are a supply of fan-folded sheet stock material 186 and a supply stand 188 (FIG. 11) for supporting the supply of fan-folded sheet stock material 186. In this embodiment, the supply of sheet stock material 186 includes a plurality of stacks 190 of fan-folded sheet stock material that are stacked one atop the other.

The supply stand 188 can have a slightly smaller width and a similar height than that of the dunnage converter stand 184. The dunnage converter stand 184 includes a pair of transversely spaced base members 194. The supply stand 188 likewise includes a pair of transversely spaced base members 196 that are spaced apart less in width than that of the transversely spaced base members 194 of the dunnage converter stand 184.

The supply stand 188 also includes a pair of transversely spaced upright members 200, a transverse support member (not shown), and a guide such as roller 201. Wheels 205 are provided at longitudinally opposite ends of the base members 196 so that the supply stand 188 may be moved easily. The transverse support member is disposed at the bottom of the supply stand 188 and is connected at its ends to the respective base members 196.

As is shown in FIG. 11, each upright member 200 of the supply stand 188 includes an inner side wall 202, an outer side wall 204 spaced from the inner side wall 202 by a gap G, a front wall 206, and a rear wall 208. The front and rear walls 206 and 208 span the gap G between the inner and outer side walls 202 and 204 and extend inwardly beyond the respective inner side walls 202 to form respective front and rear guide surfaces 210 and 212. The inner side walls 202 and respective front and rear guide surfaces 210 and 212 define a pair of inwardly-facing channels. Front and rear transverse support members 214 and 216 are connected to and extend between the upright members 200 at the upper end of the upright members 200.

As shown in FIG. 11A, the front and/or rear guide surfaces 210 and 212 may be movable. In the illustrated embodiment the front guide surfaces 210 are formed by a retention strip that is mounted by a hinge 213 to the front wall 206. These guide surfaces 210 are movable between the closed position, shown in solid lines, and an open position, shown in broken lines, to allow for insertion of a stack of sheet stock material. The guide surfaces can be held closed with any suitable means, including spring biasing, to support the stack of sheet stock material placed therein. Suitable means for holding the guide surfaces in the open position while the stack is being loaded therein, also may be provided.

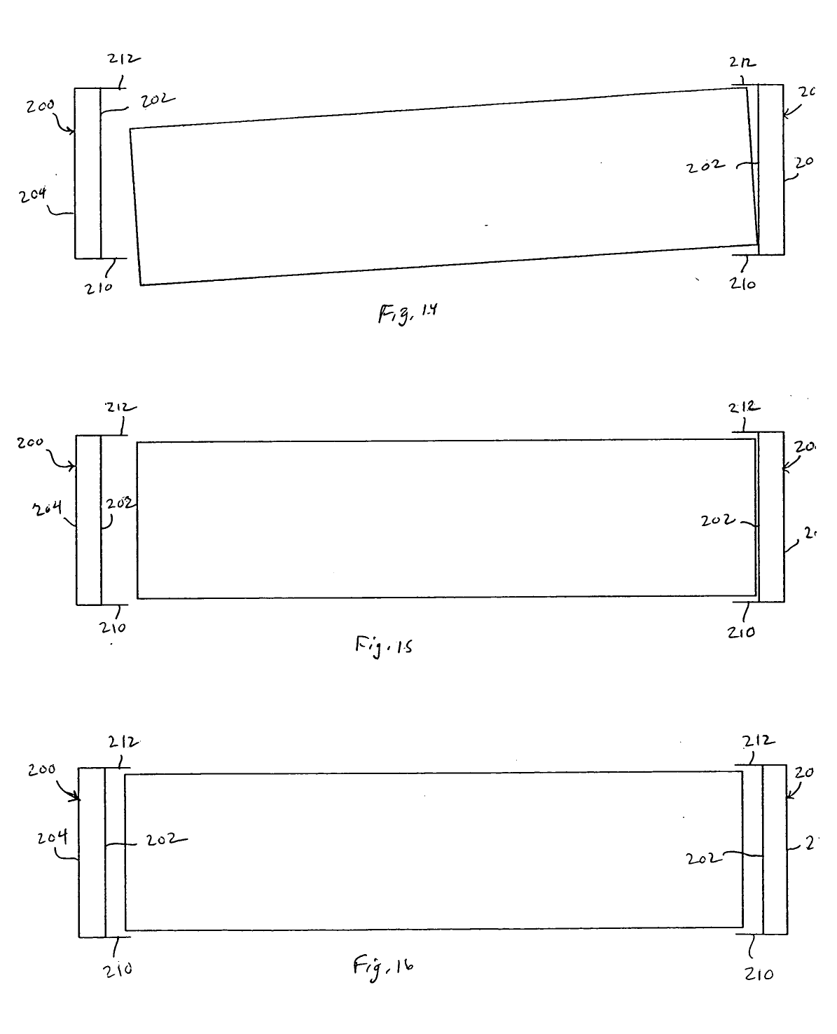

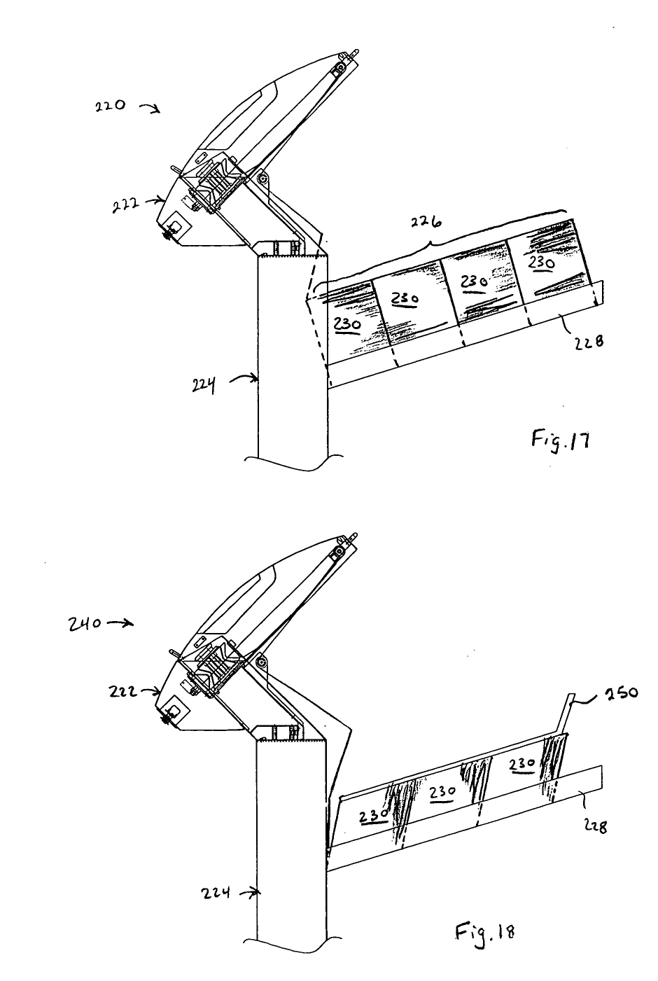

FIGS. 12-16 illustrate sequentially an exemplary method of loading a stack of fan folded sheet stock material between the upright members 200, as viewed from the top of the stack. The width of the stack is slightly less than the distance between the inner side walls 202 and slightly greater than the distance between the innermost edges of the front and rear guide walls 210 and 212. Initially, the stack is inserted sideways between the upright members 200 (FIG. 12). In the illustrated embodiment, the right side of the stack is inserted between the upright members 200, for example. The stack is then tilted clockwise until diagonally opposite corners, for example the right front corner and the rear left corner in the illustrated embodiment, are in between the upright members 200, as shown in FIG. 13. The right side of the stack is then moved towards the right inner side wall 202 so that the right rear corner of the stack clears the right rear guide wall 212 (FIG. 14). The stack is then moved further towards the right inner side wall 202 sufficient enough to enable the left front corner of the stack to clear the left front guide wall 210. The stack is then tilted clockwise until the sides of the stack are within the inner side walls 202, and the front and rear of the stack are within the front and rear guide walls 210 and 212 of the upright members 200 (FIG. 15). The stack is then shifted laterally to the left to approximately center the stack between the inner side walls 202 (FIG. 16). As a result, the fan-folded sheet stock material is captured between the inner side walls 202 and the front and rear guide walls 210 and 212. The front and rear guide walls 210 and 212 prevent or at least reduce the likelihood of the stack from tipping either rearwardly or forwardly out from the stand 188, while the inner side walls 202 of the respective upright members 200 prevent or at least reduce the likelihood of the stack from moving laterally within the stand 188. It has been found that this is particularly useful when the stand is moved from one location to another on the wheels 205.

Although in the illustrated embodiment the stack is inserted between the upright members 200 by first inserting the right side of the stack, it will be appreciated that alternative methods may be employed to insert the stack. For example, the left side of the stack may be inserted first, followed by tilting the stack counterclockwise. Also, it will be appreciated that any stack of fan folded sheet stock material may be inserted between the upright members 200 according to the invention.

The supply stand 188 can be positioned next to the dunnage converter stand 184 for supplying the sheet material to the converter. The dunnage converter 182 draws sheet stock material from the supply of sheet stock material 186 and, more particularly, the top stack 190 thereof. The sheet stock material may be guided by the roller 208. As the supply of sheet stock material 186 becomes almost spent, the almost spent supply of sheet stock material 186 may be replaced by replacing the supply stand 188 with a succeeding supply stand 188 having a succeeding supply of sheet stock material 186 thereon. The almost spent supply of sheet stock material and the succeeding supply of sheet stock material may be spliced together as in the manner described and illustrated above. Thus, for example, the trailing end of the almost spent supply of sheet stock material may be spliced to the leading end of the succeeding supply of sheet stock material. In an embodiment, an adhesive layer and release liner may be provided on the trailing end of the almost spent supply of sheet stock material or, alternatively, on the leading end of the succeeding supply of sheet stock material.

FIG. 17 illustrates a dunnage conversion system 220 in accordance with another embodiment of the present invention. The dunnage converter system 220 includes a dunnage converter 222, a dunnage converter stand 224, a supply of fan-folded sheet stock material 226, and a support device in the form of a supply tray 228 for supporting the supply of fan-folded sheet stock material 226. The supply tray 228 is inclined relative to horizontal. In the illustrated embodiment, the incline is about 15 degrees from horizontal. The supply of sheet stock material 226 includes a plurality (four in the illustrated embodiment) of stacks 230 of fan-folded sheet stock material.

To load the supply tray 228, a stack 230 of sheet stock material is set on the supply tray 228. A succeeding stack 230 is then set on the supply tray 228 and spliced to the previous stack 230. The stacks 230 are pushed together in side-by-side manner, and then slid on the supply tray 228 towards the upright members of the dunnage converter stand 224. Additional stacks 230 may be added as desired. The length of the supply tray 228 may be changed to accommodate any number of stacks 230 of sheet stock material. The stack 230 nearest the dunnage converter 222 supplies sheet stock material to the dunnage converter 222.

In accordance with the present invention, a converting process need not be interrupted in order to splice together a succeeding supply of sheet stock material and an almost spent supply of sheet stock material. For example, as a converting process is taking place, a succeeding stack 230 of sheet stock material may be spliced to the stack 230 of sheet stock material furthest away from the upright members of the dunnage converter stand 224. As the stack 230 nearest the upright members becomes nearly spent, the stacks 230 of sheet stock material in the supply tray 228 may be slid forward.

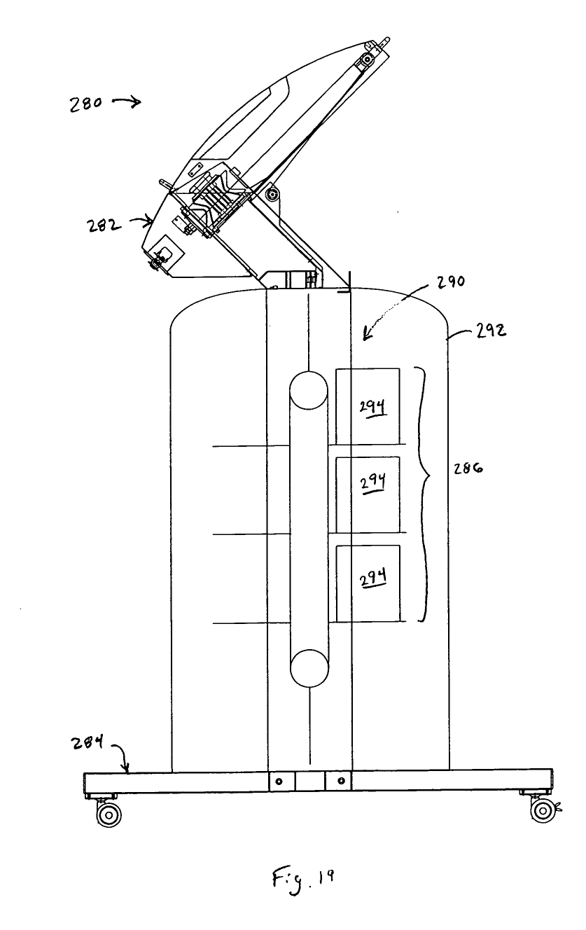

FIG. 18 shows a dunnage conversion system 240 in accordance with another embodiment of the present invention. The conversion system 240 is similar to the dunnage conversion system 220 except as described below. In the Figures, like reference numerals correspond to like components.

The dunnage conversion system 240 includes a shingle bar 250 that is substantially parallel to the supply tray 228. Together, the shingle bar 250 and supply tray 228 form a chute that has a height slightly less than the length of a page of a stack of fan-folded sheet stock material.

To load the chute, or supply tray 228 thereof, a stack 230 of fan-folded sheet stock material is inserted top side first between the shingle bar 250 and the supply tray 228. The shingle bar 250 and the supply tray 228 function to skew or shingle the pages that make up the stack 230 of sheet stock material. A succeeding stack 230 is then inserted into the chute and spliced to the previous stack 230. The stacks 230 are pushed together in top-to-bottom manner, and then slid on the supply tray 228 towards the upright members of the dunnage converter stand 224. Additional stacks 230 may be added as desired. The length of the supply tray 228 may be changed to accommodate any number of stacks 230 of sheet stock material. The stack 230 nearest the dunnage converter 222 supplies sheet stock material to the dunnage converter 222.

In accordance with the present invention, a converting process need not be interrupted in order to splice together a succeeding supply of sheet stock material and an almost spent supply of sheet stock material. Such splicing may be similar to that described above with reference to FIG. 6.

FIG. 19 illustrates a dunnage conversion system 280 in accordance with another embodiment of the present invention. The dunnage converter system 280 includes a dunnage converter 282, a dunnage converter stand 284, a supply of fan-folded sheet stock material 286, a paddle type elevator 290 for supporting and indexing the supply of fan-folded sheet stock material 286, and a cover 292 for protecting the paddle wheel elevator 290.

The paddle type elevator 290 supports multiple stacks 294 of sheet stock material. As the fan fold sheet stock material is used, the paddle type elevator 290 may be indexed upward (counterclockwise in FIG. 19), making a paddle, or space, available for a succeeding stack of sheet stock material. A sensor may be provided to detect that a stack of sheet stock material is almost spent. The elevator 290 may be actuated by any suitable means, for example, a motor or solenoid, for example.

Although the invention has been shown and described with respect to a certain preferred embodiments, equivalent alterations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment or embodiments of the invention. In addition, while a particular feature of the invention may have been described above with respect to only one of several illustrated embodiments, such feature may be combined with one or more other features of the other embodiments, as may be desired and advantageous for any given or particular application.

What is claimed is:

1. A method of supplying fan-folded sheet stock material to a dunnage converter, comprising the steps of: positioning two or more stacks of fan-folded sheet stock material proximate a dunnage converter, and feeding the sheet material from the stacks of fan-folded sheet stock material to the converter, either sequentially or simultaneously, for conversion into a dunnage product.

2. A method as set forth in claim 1, further comprising the step of loading at least one stack of fan-folded sheet stock material on a support device.

3. A method as set forth in claim 2, wherein the loading step includes loading at least one stack of fan-folded sheet stock material on a pallet.

4. A method as set forth in claim 2, wherein the loading step includes loading at least one stack of fan-folded sheet stock material on a portable support device, and the positioning step includes moving the portable support device proximate the dunnage converter

5. A method as set forth in claim 4, wherein the loading step includes loading at least one stack of fan-folded sheet stock material on a cart.

6. A method as set forth in claim 2, wherein the loading step includes loading at least one stack of fan-folded sheet stock material on a support device without interrupting the operation of the dunnage converter.

7. A method as set forth in claim 1, wherein the feeding step includes simultaneously feeding multiple plies of the fan-folded sheet stock material from respective stacks thereof to the converter for conversion into a dunnage product.

8. A method as set forth in claim 1, wherein the feeding step includes sequentially feeding a continuous ply of fan-folded sheet stock material from multiple stacks thereof to the converter for conversion into a dunnage product.

9. A method as set forth in claim 1, further comprising the step of operating a dunnage converter to produce a dunnage product.

10. A dunnage conversion system, comprising:
a dunnage converter for converting sheet stock material into a dunnage product; and
a supply of sheet stock material proximate the dunnage converter for conversion into a dunnage product, the supply including two or more stacks of fan-folded sheet stock material, the stacks being horizontally or vertically disposed relative to each other.

11. A dunnage conversion system as set forth in claim 10, including a stand for supporting the dunnage converter, the stand including a pair of transversely spaced upright members.

12. A dunnage conversion system as set forth in claim 11, wherein the upright members are transversely spaced apart a distance sufficient to receive the supply of sheet stock material therebetween.

13. A dunnage conversion system as set forth in claim 10, further comprising a support device on which a least one stack of sheet stock material is loaded.

14. A dunnage conversion machine as set forth in claim 13, wherein the support device includes a pallet.

15. A dunnage conversion machine as set forth in claim 13, wherein the support device includes a cart.

16. A dunnage conversion system as set forth in claim 10, wherein the stand further includes at least one transverse support member connected at its opposite ends to the upright members.

17. A dunnage conversion system as set forth in claim 16, wherein the at least one transverse support member is selectively moveable between a bottom of the upright members to a position higher than the height of the stacks of sheet stock material.

18. A supply of sheet stock material for use with a dunnage converter, comprising a continuous ply of sheet stock material that is fan-folded, and includes a series of folds that together form a sequence of rectangular pages, the pages being piled accordion style one on top of the other to form multiple stacks of sheet stock material.

19. The supply as set forth in claim 18, in combination with a support device on which the stacks of sheet stock material are loaded.

20. The combination as set forth in claim 19, wherein the support device includes a pallet.

21. The combination as set forth in claim 20, wherein the stacks of fan-folded sheet stock material are horizontally stacked on the pallet.

22. The combination as set forth in claim 19, wherein the support device includes a cart.

23. The combination as set forth in claim 22, wherein the stacks of fan-folded sheet stock material are vertically stacked on the cart.

24. The combination as set forth in claim 19, wherein the support device includes an inclined supply tray.

25. The combination as set forth in claim 24, wherein the stacks are loaded on the supply tray side-by-side.

26. The combination as set forth in claim 24, wherein the stacks are loaded on the supply tray top-to-bottom.

27. The combination as set forth in claim 26, further comprising a shingle bar spaced from the supply tray less than a length of a rectangular page of the stack of sheet stock material to shingle the pages of the stacks.

28. The combination as set forth in claim 19, wherein the support device includes an indexable elevator.

29. In combination, a dunnage converter, and a portable support device for supporting at least one stack of fan-folded sheet stock material and from which stock material is supplied to the dunnage converter when the support device is positioned in proximity thereto.

30. The combination as set forth in claim 29, wherein the support device includes a cart.

31. The combination as set forth in claim 30, wherein multiple stacks of fan-folded sheet stock material are vertically stacked on the cart.

32. The combination as set forth in claim 31, wherein the multiple stacks of fan-folded stock material are formed by a continuous ply of sheet stock material that is fan-folded, and includes a series of folds that together form a sequence of rectangular pages, the pages being piled accordion style one on top of the other to form multiple stacks of sheet stock material vertically stacked on the cart.

33. A cart for supporting at least one stack of sheet stock material, comprising: a pair of spaced upright members adapted to receive therebetween at least one stack of fan-folded sheet stock material, the upright members having an inward-facing channel for supporting the sides of the stock material to maintain the stack upright.

34. A cart as set forth in claim 33, in combination with at least one stack of fan-folded sheet stock material.
